(19) United States
(12) Patent Application Publication
(10) Pub. No.: US 2014/0305126 A1
(43) Pub. Date: Oct. 16, 2014

(54) FLOW VELOCITY DISTRIBUTION EQUALIZING APPARATUS

(71) Applicant: KAWASAKI JUKOGYO KABUSHIKI KAISHA, Kobe-shi (JP)

(72) Inventors: Yasushi DOURA, Kobe-shi (JP); Masahiro OGATA, Kobe-shi (JP); Kousuke TANAKI, Kakogawa-shi (JP)

(73) Assignee: KAWASAKI JUKOGYO KABUSHIKI KAISHA, Kobe-shi (JP)

(21) Appl. No.: 14/317,777

(22) Filed: Jun. 27, 2014

Related U.S. Application Data
(63) Continuation of application No. PCT/JP2012/083592, filed on Dec. 26, 2012.

(30) Foreign Application Priority Data
Dec. 28, 2011 (JP) 2011-288019

(51) Int. Cl. F02C 7/22

(52) U.S. Cl. CPC F02C 7/22
USPC 60/734

(57) ABSTRACT

An apparatus for equalizing flow velocity distribution of a fuel gas supplied into a catalytic combustor includes a rectification vane and a rectification plate in an inlet chamber of the catalyst combustor. The inlet chamber has a round transverse sectional shape and includes an inflow port that allows the fuel gas to inflow radially, and an outflow port for discarding the fuel gas axially. The rectification vane has a front edge oriented towards the inflow port, and a rectifying surface ramified from the front edge so as to extend towards a cylindrical inner wall surface of the inlet chamber such that swirling flow of the fuel gas flown into the inlet chamber, that flows towards the inflow port along the cylindrical inner wall surface, is generated. The rectification plate is located at the outflow port and has openings for allowing the fuel gas to flow therethrough.

### CROSS REFERENCE TO THE RELATED APPLICATION

This application is a continuation application, under 35 U.S.C. §111(a), of international application No. PCT/JP2012/083592, filed Dec. 26, 2012, which claims priority to Japanese patent application No. 2011-288019, filed Dec. 28, 2011, the disclosure of which are incorporated by reference in their entirety into this application.

### DESCRIPTION OF RELATED ART

The present invention relates to an apparatus for equalizing a flow velocity distribution of a gas flowing into a catalytic combustor in a gas turbine engine.

### SUMMARY OF THE INVENTION

The catalytic combustor mounted on gas turbine engines has advantage relative to the conventional art, including little emission of NOx when an inflow gas is combusted by catalytic reaction and capability of oxidizing a low concentration methane, which cannot be ordinarily combusted and is therefore emitted to the atmosphere. Therefore, the catalytic combustor referred to above is considered superior in dealing with environment related issues including, for example, low emission and global warming. On the other hand, the catalytic combustor has some demerits such as, for example, expensiveness and short life.

Specifically, catalytic combustion under a high pressure condition such as in the gas turbine engine, particularly where the flow velocity distribution of a compressed gas containing a fuel at the inlet to the catalytic combustor varies considerably, is liable to develop uneven temperature distribution within the catalyst, accompanied by reduction in life of the catalyst. Accordingly, equalization of the flow velocity distribution at the inlet to the catalyst combustor is considered one of important design factors. In order to accomplish the equalization of the flow velocity distribution, the method has been known in which the compressed gas is allowed to flow within a fluid passage of a long and straight length provided in the vicinity of the inlet of the catalytic combustor to thereby equalize the flow velocity. Also, another method has been employed in which, in order to equalize the flow velocity in the gas turbine combustor of a type not utilizing the catalyst, a rectifier plate such as, for example, a punching metal is provided in the vicinity of the inlet of the combustion chamber (See the patent document 1 listed below.).

It has, however, been found that the use of the flow passage having a long and straight length requires a large piping space which leads to an increase of the size. On the other hand, regarding the equalization of the flow velocity distribution of the catalytic combustor with the use of the rectifier plate, case examples have not been available. Where the rectifier plate is used, the pressure loss tends to increase and, if the flow velocity distribution on an upstream side of the rectifier plate changes considerably, the rectifier plate, which is a fixed throttling plate, is incapable to accommodate.

### PATENT DOCUMENT

Patent Document 1: JP Laid-open Patent Publication No. 2009-52768

In view of the foregoing, the present invention has for its object to provide a flow velocity distribution equalizing apparatus capable of equalizing the flow velocity distribution at the inlet of the catalytic combustor with a minimized pressure loss and without incurring the increase in size.

In order to accomplish the foregoing object, the flow velocity distribution equalizing apparatus herein provided in accordance with the present invention is an apparatus for equalizing a flow velocity distribution of a fuel gas to be supplied into a catalytic combustor, comprising: a rectification vane and a rectification plate provided in an inlet chamber of the catalyst combustor, in which the inlet chamber has a round transverse sectional shape and includes an inflow port that allows the fuel gas to inflow in a radial direction thereof, and an outflow port through which the fuel gas is discharged in an axial direction, and the rectification vane has a front edge oriented towards the inflow port, and has a rectifying surface ramified from the front edge so as to extend towards a cylindrical inner wall surface of the inlet chamber such that a swirling flow of the fuel gas flown into the inlet chamber, that flows towards the inflow port along the cylindrical inner wall surface, is generated. The rectification plate is located at the outflow port and having a multiplicity of openings defined therein for allowing the fuel gas to flow therethrough.

According to the flow velocity distribution equalizing apparatus, the fuel gas flowing from the inflow port into the inlet chamber of the catalytic combustor is, after having been ramified from the front edge of the rectification vane so as to flow along the rectifying surface on both sides, guided so as to flow along a cylindrical inner wall surface of the inlet chamber towards the inflow port and a swirling flow is then generated. Since in this way the fuel gas is fluidized so as to be stirred within the inlet chamber and returned backwards by the rectification vane, equalization of the flow velocity distribution is promoted. The fuel gas, of which the flow velocity distribution has been beforehand equalized by the rectification vane, is guided so as to change the direction of low at right angles while flowing along the cylindrical wall surface of the inlet chamber of a round sectioned shape, and is then equalized in flow velocity distribution as it pass through a multiplicity of openings of the rectification plate disposed at an outflow port. Thus, the flow velocity equalizing apparatus of the present invention can effectively equalize the flow velocity distribution of the fuel gas by accomplishing the two staged rectification by the rectification vane and the rectification plate even though the flow velocity distribution changes by reason of a change of the flow quantity of the fuel gas.

In addition, according to the flow velocity distribution equalizing apparatus of the present invention, since the fuel gas flowing in a radial direction from the inflow port towards the inlet chamber of the catalytic combustor is guided towards the outflow port after having been changed its direction of flow to a direction transverse thereto, unlike the case in which the use is made of a long, straight flow passage, the apparatus as a whole will not be increased in size. Also, since the fuel gas flowing into the inlet chamber of the catalytic combustor is guided in an axial direction towards the rectification plate after the direction of flow thereof has been changed to the axial direction while swirling as guided by the rectification vane, the pressure loss of the fuel gas brought about by the change of the direction of flow is minimal as compared with the case in which the entire amount of an inflowing gas is caused to impinge upon the inner wall surface of the catalytic combustor to thereby forcibly change the direction of flow thereof to a direction transverse thereto.

In one embodiment of the present invention, the front edge of the rectification vane referred to above may confront radially the entirety of the inflow port in the axial direction of the inlet chamber. By so doing, the fuel gas flowing from the inflow port into the inlet chamber in the radial direction is guided so as to inflow in a direction along opposite outer surfaces of the rectification vane.

In one embodiment of the present invention, the rectification vane may have a transverse sectional shape representing an isosceles triangle and, specifically, a vertex angle of the isosceles triangle may be within a range of 10 to 40°. According to these structural features, since the fuel gas flowing from the inflow port into the inlet chamber in the radial direction can be divided into two equal parts and is then guided along the opposite outer surfaces of the rectification vane, a swirling flow which accelerates equalization of the flow velocity distribution can be generated.

In one embodiment of the present invention, the rectification plate may have round large diametric holes, formed in an area remote from the inflow port, and round small diametric holes each having a diameter smaller than that of the large diametric holes, in an area adjacent to the inflow port. By so designing, of the fuel gas supplied from the rectification vane, a portion of the fuel gas flowing through the area remote from the inflow port flows through the large diametric holes in the rectification plate in a condition, in which the flow velocity is reduced to a relatively low value as a result of a strong impingement on the inner wall surface of the inlet chamber, and the remaining portion of the fuel gas flowing through the area adjacent to the inflow port has its flow velocity being decreased as it flows past the small diametric holes in the rectification plate. Accordingly, the flow velocity distribution of the fuel gas, of which flow velocity distribution has been equalized by the rectifying action of the rectification vane beforehand, can be further equalized. Moreover, since the large and small diametric holes are round, it is possible to easily form.

In one embodiment of the present invention, the inlet chamber may have an inner diameter within a range of 1.5 to 2.0 times a diameter of the inflow port. By so doing, the fuel gas flowing from the inflow port into the inlet chamber is, after having been decelerated because of the inner diameter of the inlet chamber being greater than the diameter of the inflow port, smoothly guided towards the rectification vane.

In one embodiment of the present invention, the inlet chamber may be formed inside an upstream portion of the combustion container accommodating therein a combustion catalyst of the catalytic combustor. By so doing, the combustion container can be concurrently used as a housing for the flow velocity distribution equalizing apparatus.

In one embodiment of the present invention, the flow velocity distribution equalizing apparatus may be mounted on a gas turbine engine. As a specific example, the flow velocity distribution equalizing apparatus of the present invention may be applied to a lean fuel type, in which a low calorie fuel gas is compressed by a compressor, and subsequently combusted in the catalytic combustor. For example, where the flow velocity distribution equalizing apparatus of the present invention is applied to a gas turbine engine of a type which utilizes a low calorie fuel gas comprised of a compressed mixture of VAM and CMM, not only can the mixing of the fuel gas be accelerated, but also the flow velocity distribution can be equalized.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a block diagram showing a schematic structure of a gas turbine engine equipped with a flow velocity distribution equalizing apparatus designed in accordance with a embodiment of the present invention;

FIG. 2 is a schematic longitudinal sectional view showing the flow velocity distribution equalizing apparatus;

FIG. 3 is a schematic transverse sectional view showing the flow velocity distribution equalizing apparatus; and

FIG. 4 is a schematic top plan view showing a rectification plate employed in the flow velocity distribution equalizing apparatus.

### DESCRIPTION OF EMBODIMENTS

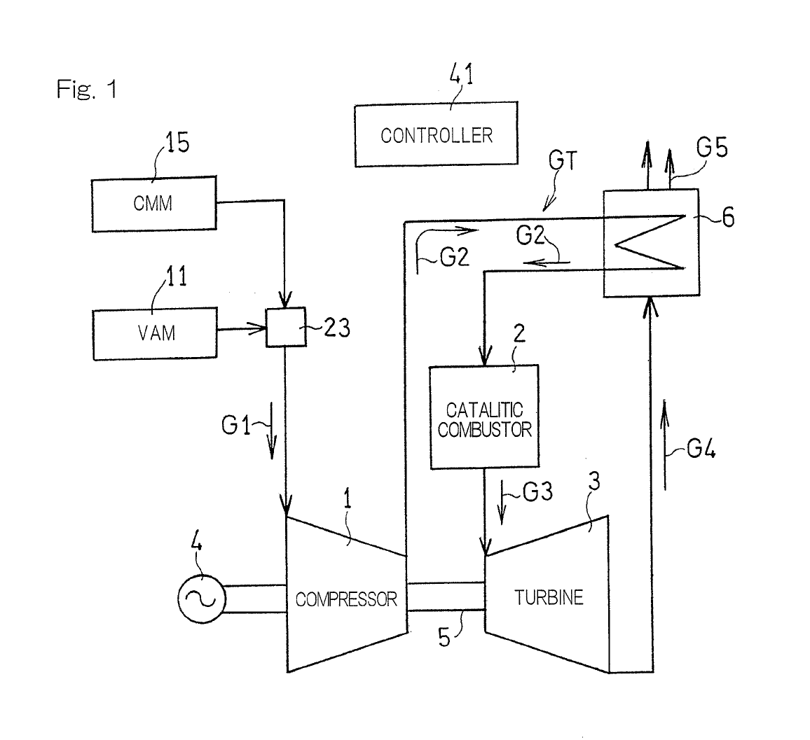

Reference will now be made to the accompanying drawings for the details of a flow velocity distribution equalizing apparatus designed in accordance with an embodiment of the present invention. In particular, FIG. 1 illustrates a block diagram showing a schematic structure of a gas turbine engine GT employing the flow velocity distribution equalizing apparatus in accordance with an embodiment of the present invention, in which a gas turbine engine GT configured to utilize a lean fuel is illustrated as an example. This gas turbine engine GT includes a compressor 1, a catalytic combustor 2 utilizing a catalyst such as, for example, platinum and/or palladium, and a turbine 3. This gas turbine engine GT provides an output to drive an electric power generator 4.

As a low calorie fuel gas used in the gas turbine engine GT, the following gases may be employed. Specifically, from a VAM (ventilation air methane) supply source, a VAM produced in coal mines is supplied and a CMM (coal mine methane) having a higher concentration of a combustible component (methane) than that of the VAM is supplied from a CMM supply source 15. The fuel gases as those types of the VAM and the CMM, which have respective fuel concentration different from each other, are mixed together by a mixer 23 to produce a working gas G1; and the working gas G1, which is a low calorie gas, is supplied into the gas turbine engine GT through an intake port of the compressor 1. This working gas G1 has a combustible component concentration which does not undergo a spontaneous ignition within the compressor 1.

The working gas G1 is compressed by the compressor 1 and the resultant high pressure compressed gas G2 is then supplied to the catalytic combustor 2 as a fuel gas. This compressed gas G2 is combusted by a catalytic reaction of the catalyst such as, for example, platinum and/or palladium of the catalytic combustor 2 and the resultant high temperature, high pressure combustion gas G3 is supplied to the turbine 3 to drive such turbine 3. The turbine 3 is drivingly connected with the compressor 1 through a rotary shaft 5 and the compressor 1 is driven by this turbine 3.

The gas turbine engine GT also includes a heat exchanger 6 for heating the compressed gas G2, to be supplied from the compressor 1 to the catalytic combustor 2, by means of an exhaust gas G4 supplied from the turbine 3. The exhaust gas G5 discharged from the heat exchanger 6 is, after having been silenced through a silencer (not shown), discharged to the outside. In fuel supply passages from the VAM supply source 11 and the CMM supply source 15 to the gas turbine engine GT are provided with a plurality of fuel control valves and methane concentration meters at appropriate locations and those fuel control valves are controlled by a controller 41 in dependence on fuel concentration values detected by the methane concentration meters and, accordingly, the working gas G1 is controlled to a fuel concentration required to produce a rated output and is then supplied to the compressor 1.

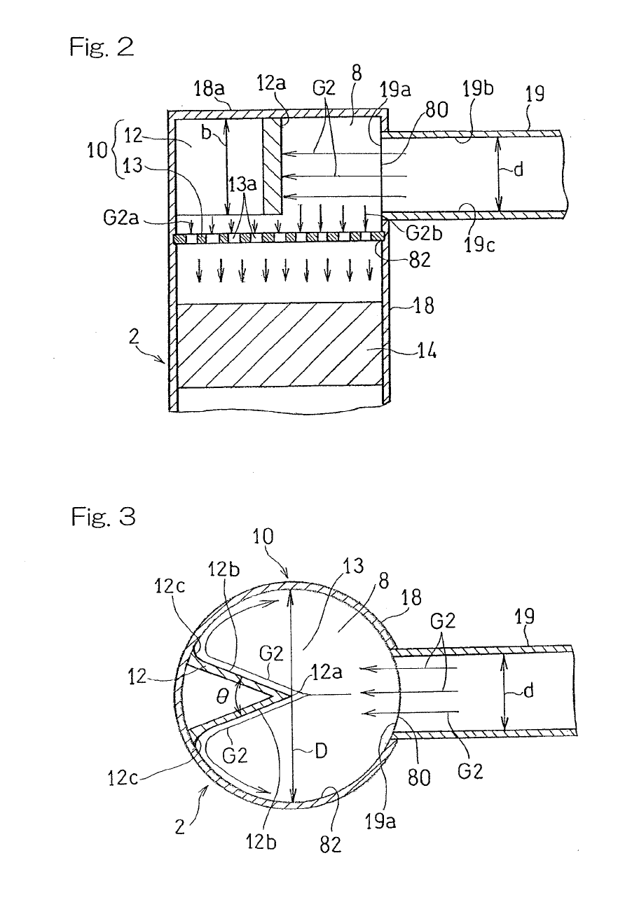

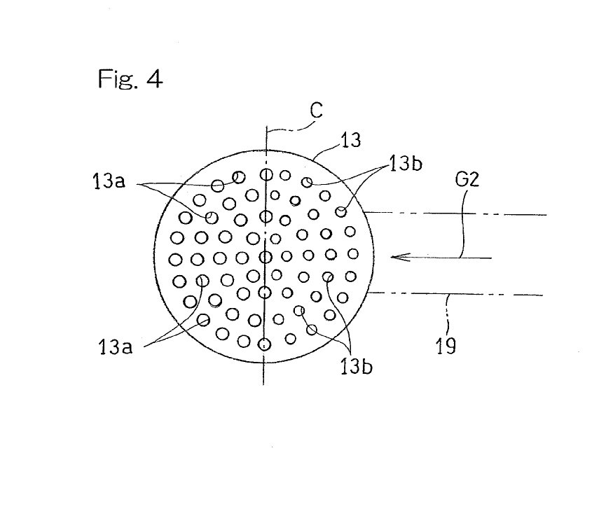

The catalytic combustor 2 shown in FIG. 1 is equipped with the flow velocity equalizing apparatus which is designed in accordance the embodiment of the present invention. FIGS. 2 and 3 illustrate respective schematic longitudinal and transverse sectional views of the flow velocity distribution equalizing apparatus 10. This flow velocity distribution equalizing apparatus 10 includes a rectification vane 12 and a rectification plate 13 positioned downstream of the rectification vane 12 as shown in FIG. 2. The catalytic combustor 2 referred to above has a combustion catalyst 14 such as, for example, platinum and/or palladium accommodated within an interior of a capitates cylindrical combustion container 18 having an axial direction substantially parallel to the vertical direction.

The flow velocity distribution equalizing apparatus 10 is disposed on an upstream side of the site where the combustion catalyst 14 in a combustion container 18, that is, at a location upwardly of the combustion catalyst 14 in the combustion container 18. In other words, an inlet chamber 8 leading to the combustion catalyst 14 is defined inside an upstream portion of the combustion container 18 and the rectification vane 12 and the rectification plate 13 are disposed in the inlet chamber 8. The inlet chamber 8 is of a transverse round sectional shape and an inflow port 80 defined somewhat below an upper end of a peripheral wall is connected with a gas supply tube 19 through which a compressed gas G2 is supplied from a heat exchanger 6 shown in FIG. 1. The gas supply tube 19 allows the compressed gas G2 through the inflow port 80 to flow towards the flow velocity distribution equalizing apparatus 10 in a direction radially of the combustion container 18, that is, in a direction radially of the inlet chamber 8.

As shown in FIG. 3, the rectification vane 12 has a transverse sectional shape representing a isosceles triangle shape. The rectification vane 12 is fixed to an inner wall surface of the combustion container 18, which faces the inflow port 80 for the compressed gas (fuel gas) G2, that is, an outlet 19a of the gas supply tube 19, in a manner in which a vertex of the isosceles triangle represented by the sectional shape of the rectification vane 12 is oriented in a direction reverse to the direction of flow of the compressed gas G2. The rectification vane 12 having an outer shape represented by the isosceles triangle shape referred to above may have its vertex angle θ preferably within the range of 10 to 40° and, more preferably, within the range of 15 to 35°. In the embodiment now under discussion the angle θ of the vertex of the rectification vane 12 is set to 30°.

The rectification vane 12, having so designed as hereinabove described, has rectifying surfaces 12b ramified from a front edge 12a defining the vertex thereof and protruding inwardly of the inlet chamber 8, which surfaces 12b extend towards a cylindrical inner wall surface of the inlet chamber 8 so as to terminate at base end portions 12c in rigid contact with the inner wall surface of the inlet chamber 8. The rectification vane 12, except for its base end portions 12c, has a major portion thereof representing the isosceles triangular shape.

An upper end of the rectification vane 12 as shown in FIG. 2 is held in contact with an upper end surface of the inlet chamber 8, that is, an inner surface of an upper end wall 18a of the combustion container 18. The rectification vane 12 has its length b, that is, the dimension b as measured in a direction parallel to the axial direction of the combustion container 18 so chosen as to be somewhat greater than the inner diameter d of the gas supply tube 19, that is, the diameter d of the inflow port 80. Although the rectification vane 12 has an upper end positioned somewhat above the level of an upper end 19b of a passage within the gas supply tube 19, it may be in flush with the upper end 19b. On the other hand, the rectification vane 12 has a lower end held in flush with or somewhat below a lower end 19c of the passage of the gas supply tube 19. In other words, in the axial direction of the inlet chamber 8, the rectification vane 12 confronts radially the entirety of the inflow port 80.

Also, respective areas in the vicinity of the base end portions 12c of the rectification vane 12, which define opposite areas fixed to the combustion container 18 as shown in FIG. 3, are so formed as flared areas smoothly continued to opposite portions of the inner wall surface of the combustion container 18. It is to be noted that the inner diameter D of the combustion container 18 is so chosen as to be within the range of 1.5 to 2.0 times the inner diameter d of the gas supply tube 19, that is, the diameter d of the inflow port 80.

On the other hand, the rectification plate 13 is fitted to an outflow port 82 of the inlet chamber 8 and is positioned at a portion of the inner wall surface of the combustion container 18 on an upstream side of the combustion catalyst 14 and in the vicinity of its inlet port. The rectification plate 13 is in the form of a punched metal disc engageable within the combustion container 18, which disc has a multiplicity of openings in the form of, for example, a group of large diametric holes 13a such as, for example, large round holes and a group of small diametric holes 13b such as, for example, small round holes. The large diametric holes 13a and the small diametric holes 13b are employed in equal numbers and are disposed in the same layout in respective equal half areas of the rectification plate 13.

Specifically, with respect to the center line C of the rectification plate 13 extending perpendicular to the direction of flow of the compressed gas G2 in the gas supply tube 19, a semicircular area of the rectification plate 13 remote from the outlet 19a (inflow port 80) of the gas supply tube 19 is formed with the large diametric holes 13a and the remaining semicircular area of the rectification plate 13 adjacent to the outlet 19a (inflow port 80) with respect to the center line C is formed with the small diametric holes 13b. The large diametric holes 13a have an aperture size that is about 1.2 times the aperture size of the small diametric holes 13b. Both of the large diametric holes 13a and the small diametric holes 13b may not be necessarily limited to round holes, but may be of elliptical, oval or slit shapes, noting that if they are round in shape, they can be easily formed.

As shown in FIG. 3, in the flow velocity distribution equalizing apparatus 10, the compressed gas G2 flowing from the gas supply tube 19 into the combustion container 18 is decelerated, because the inner diameter D of the combustion container 18 is greater than the inner diameter d of the gas supply tube 19. In addition, the compressed gas G2 is guided so as to flow in a direction along opposite outer surfaces of the rectification vane 12 of the insolences triangular shape, as shown in FIG. 3, because the lengthwise dimension b of the rectification vane 12 shown in FIG. 2 confronts the entirety of the outlet 19b of the gas supply tube 19. In this condition, the compressed gas G2 flows towards the rectification plate 13, as shown in FIG. 2, while swirling along the flared base end portions 12c on opposite sides of the rectification vane 12 and the respective portions of the inner wall surface of the combustion container 18 continued thereto, so as to travel towards the inflow port 80.

The flow velocity distribution equalizing apparatus 10 of the structure described above is of a construction in which the compressed gas G2, which has flown from the gas supply tube 19 in a substantially horizontal direction, is guided by the capitates cylindrical combustion container 18 in a direction perpendicular to the direction of inflow (in a direction right downwards of the drawing). Accordingly, unlike the case in which the use is made of a flow passage having a long straight length, the apparatus as a whole will not be increased in size.

Moreover, the compressed gas G2 flowing into the inlet chamber 8 in a radial direction is guided towards the combustion catalyst 14 on the downstream side after the direction of flow has been changed to the axial direction while having been guided by the rectification vane 12 so as to swirl. Accordingly, as compared with the conventional apparatus in which all of the gases flowing thereinto are impinged directly on the inner wall surface of the combustion container to forcibly change the direction of flow to the transverse direction, the pressure loss of the compressed gas G2, which is brought about by the change of the direction of flow, is extremely small. Also, since the rectifying vane 12 allows the compressed gas G2 to flow as though it is stirred, the compressed gas G2 may be sent to the rectification plate 13 with the flow velocity distribution thereof being effectively equalized.

The compressed gas G2, of which the flow velocity distribution has been equalized beforehand by the rectification vane 12, is further equalized as it flows across the rectification plate 13. At this time, the compressed gas G2a, which flows in the area remote from the outlet 19a of the gas supply tube 19, has its flow velocity reduced to a relatively low value as a result of strong impingement upon the inner wall surface of the combustion container 18 and this compressed gas G2a passes through the large diametric holes 13a of the rectification plate 13. On the other hand, the compressed gas G2b flowing through the area adjacent to the outlet 19b of the gas supply tube 19 and having its flow velocity relatively high, has its flow velocity reduced as it flows through the small diametric holes 13b of the rectification plate 13. Accordingly, the flow velocity distribution of the compressed gas G2 is further equalized. In this way, the flow velocity distribution equalizing apparatus 10 is of the structure in which two staged rectification by means of the rectification vane 12 and the rectification plate 13 may be implemented even when the flow velocity distribution of the compressed gas G2 changes as a result of change in, for example, the flow of the compressed gas G2. Accordingly, the flow velocity distribution equalizing apparatus 10 is effective to equalize the flow velocity distribution of the compressed gas G2 before it is supplied to the combustion catalyze 14.

Also, in this flow velocity distribution equalizing apparatus 10, since the inlet chamber 8 is formed inside an upstream portion of the combustion container 18 accommodating the combustion catalyst 14 of the catalyst combustor 2 therein, the combustion container 18 can be concurrently used as a housing for the flow velocity distribution equalizing apparatus 10. Accordingly, the structure of the apparatus is correspondingly simplified.

It is to be noted that although in describing the embodiment the compressed gas G2 containing a mixture of the VAM and the CMM is used as the low calorie gas for the gas turbine engine GT, the present invention can be equally applied to the gas turbine engine which utilizes the fuel in the form of, for example, natural gas or kerosene. It is also to be noted that it can be utilized as an apparatus for equalizing the flow velocity distribution within a gas passage other than that in the gas turbine engine.

Although the present invention has been fully described in connection with the embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

2 . . . Catalytic combustor

8 . . . Inlet chamber

10 . . . Flow velocity distribution equalizing apparatus

12 . . . Rectification vane

12a . . . Front edge

12b . . . Rectifying surface

13 . . . Rectification plate

13a . . . Large diametric hole (Opening)

13b . . . Small diametric hole (Opening)

14 . . . Combustion catalyst

18 . . . Combustion container

19 . . . Gas supply tube

G2, G2a, G2b . . . Compressed gas (Fuel gas)

GT . . . Gas turbine engine

D . . . Inner diameter of inlet chamber

d . . . Diameter of inflow port

What is claimed is:

1. An apparatus for equalizing a flow velocity distribution of a fuel gas to be supplied into a catalytic combustor, comprising:
a rectification vane and a rectification plate provided in an inlet chamber of the catalyst combustor;
the inlet chamber having a round transverse sectional shape and including an inflow port that allows the fuel gas to inflow in a radial direction thereof, and an outflow port through which the fuel gas is discharged in an axial direction;
the rectification vane having a front edge oriented towards the inflow port, and having a rectifying surface ramified from the front edge so as to extend towards a cylindrical inner wall surface of the inlet chamber such that a swirling flow of the fuel gas flown into the inlet chamber, that flows towards the inflow port along the cylindrical inner wall surface, is generated; and
the rectification plate being located at the outflow port and having a multiplicity of openings defined therein for allowing the fuel gas to flow therethrough.

2. The flow velocity distribution equalizing apparatus as claimed in claim 1, wherein the front edge of the rectification vane confronts radially the entirety of the inflow port in the axial direction of the inlet chamber.

3. The flow velocity distribution equalizing apparatus as claimed in claim 1, wherein the rectification vane has a transverse sectional shape representing an isosceles triangle.

4. The flow velocity distribution equalizing apparatus as claimed in claim 3, wherein a vertex angle of the isosceles triangle is within a range of 10 to 40°.

5. The flow velocity distribution equalizing apparatus as claimed in claim 1, wherein the rectification plate has round large diametric holes, formed in an area remote from the inflow port, and round small diametric holes each having a diameter smaller than that of the large diametric holes, in an area adjacent to the inflow port.

6. The flow velocity distribution equalizing apparatus as claimed in claim 1, wherein the inlet chamber has an inner diameter within a range of 1.5 to 2.0 times a diameter of the inflow port.

7. The flow velocity distribution equalizing apparatus as claimed in claim 1, wherein the inlet chamber is formed inside an upstream portion of a combustion container accommodating therein a combustion catalyst of the catalytic combustor.

8. The flow velocity distribution equalizing apparatus as claimed in claim 1, which is mounted on a gas turbine engine.

9. The flow velocity distribution equalizing apparatus as claimed in claim 8, wherein the gas turbine engine is of a lean fuel type, in which a low calorie fuel gas is compressed by a compressor and subsequently combusted in the catalytic combustor.
